(19) United States
(12) Patent Application Publication
(10) Pub. No.: US 2025/0105573 A1
(43) Pub. Date: Mar. 27, 2025

(54) CRIMP TOOL HAVING NON-LINEAR CRIMPING FORCE AND RELATED METHODS

(71) Applicant: Daniels Manufacturing Corporation, Orlando, FL (US)

(72) Inventor: Isaac GRAFF, Orlando, FL (US)

(21) Appl. No.: 18/371,677

(22) Filed: Sep. 22, 2023

(51) Int. Cl. H01R 43/042

(52) U.S. Cl. CPC H01R 43/0424

(57) ABSTRACT

A crimp tool for crimping a prepared wire into a corresponding contact wire barrel includes a circular cam having an aperture therein, where the aperture forms an inner camming surface. The crimp tool also includes a cam handle extending from the circular cam, a lower handle pivotably connected to the cam handle at the circular cam, and an indentor holder mounted within the aperture of the circular cam, where the indentor holder has a plurality of radially extending channels or holes. In addition, the crimp tool includes a plurality of indentor elements slidingly engaged with the plurality of radially extending channels, where the inner camming surface has a plurality of curvilinear ramps for the plurality of indenter elements to slide along as the circular cam rotates from an open position to a closed position. The plurality of curvilinear ramps have at least one change in ramp geometry.

### TECHNICAL FIELD

The present invention relates to the field of crimping tools, and, more particularly, to a crimp tool having non-linear crimping force and related methods.

### BACKGROUND

Connectors used for aircraft applications generally comply with military specifications (mil spec) standards. The connectors utilize a plurality of male pins and female sockets in opposite ends of a mating connector pair to complete electrical connections between wire leads or conductors. Typically, the pin and socket contacts are small diameter elements that are replaceable in each of the mating connector pairs.

A typical male pin has an end portion that is generally solid and a rear portion which is hollow and known as a contact wire barrel. The contact wire barrel is designed to receive a bare or stripped wire. The female socket has a similar contact wire barrel for receiving a wire. Such pins and sockets generally require only a single crimp of the respective contact wire barrel in order to fasten the pin or socket to the wire. When a complex wire harness is constructed, hundreds, perhaps thousands, of contacts are terminated by individually crimping a prepared wire into the contact wire barrel.

A crimp tool for this purpose typically has four crimping elements (indenters or crimping dies) positioned at 90° to each other. The crimping elements advance toward the center of an opening in the tool with a uniform and controlled path when the crimp tool is actuated by closing a handle manually, or actuated using a power source.

One type of crimp tool is referred to as a four (4) plane crimp tool. In the industry, it is often referred to as the 4/8 indent crimp configuration, since it usually has two points on each indenter element. The contact wire barrel is slipped over a prepared wire and the indentor elements (also referred to herein as crimp dies) form the indentions to crimp the respective contact to the wire. The crimp tool provides a linear mechanical advantage no matter how big or small the dimeter of the contact wire barrel of the pin or socket.

### SUMMARY

In view of the foregoing background, it is therefore an object of the present invention to provide a crimp tool that has a continuously variable mechanical advantage optimized for large contact wire barrels. This and other objects, features, and advantages in accordance with the present invention are provided by a crimp tool for crimping a prepared wire into a corresponding contact wire barrel. The crimp tool includes a circular cam having an aperture therein, where the aperture forms an inner camming surface. The crimp tool also includes a cam handle extending from the circular cam, a lower handle pivotably connected to the cam handle at the circular cam, and an indentor holder mounted within the aperture of the circular cam. The indentor holder has a plurality of radially extending channels or holes, and a plurality of indentor elements slidingly engaged with the plurality of radially extending channels. The inner camming surface has a plurality of curvilinear ramps for the plurality of indenter elements to slide along as the cam handle is compressed to rotate the circular cam from an open position to a closed position.

In addition, the plurality of curvilinear ramps may have at least one change in ramp geometry, where a first portion has a first rate of change in radius, and a second portion has a second rate of change in radius less than the first change in radius. Accordingly, a force exerted by proximal ends of the plurality of indentor elements on a contact wire barrel may change as the circular cam rotates to the closed position.

The rotation of the circular cam from an open position to a closed position is configured to drive the indentor elements radially inward. The indentor holder remains stationary relative to the circular cam that is configured to rotate when the cam handle is compressed towards the lower handle. The plurality of indentor elements may have a plurality of spring elements forcing distal ends of the plurality of the indentor elements to maintain continuous contact with the inner camming surface.

The distal ends of the plurality of indentor elements may have a rounded head to continuously maintain contact with the inner camming surface. The inner camming surface may have a plurality of recesses associated with each ramp of the plurality of curvilinear ramps and configured to receive a respective rounded head of the plurality of indentor elements therein when the circular cam is in the open position.

In another aspect, a method of using a crimp tool comprising a circular cam having an inner camming surface where the inner camming surface has a plurality of curvilinear ramps is disclosed. The method includes compressing a cam handle extending from the circular cam that causes the circular cam to rotate. In addition, the method includes driving a plurality of indentor elements radially inward by the plurality of curvilinear ramps in response to the rotation of the circular cam to crimp a prepared wire into a corresponding contact wire barrel. The plurality of curvilinear ramps include a first portion having a first rate of change in radius, and a second portion having a second rate of change in radius different than the first change in radius. Accordingly, a force exerted by proximal ends of the plurality of indentor elements on the contact wire barrel changes as the circular cam rotates to a closed position.

### BRIEF DESCRIPTION OF THE DRAWINGS

FIG. 1 is an elevational view of a crimp tool in which various aspects of the disclosure may be implemented;

FIG. 2 is a longitudinal cross-sectional view of the crimp tool of FIG. 1 in an open position;

FIG. 3 is a longitudinal cross-sectional view of the crimp tool of FIG. 1 in a closed position;

FIG. 4. is a detailed view of the indentor holder and cam;

FIG. 5 is a detailed view of an inner camming surface and curvilinear ramps;

FIG. 6 is a detailed of the inner camming surface and distal end of an indentor element;

FIG. 7 is a detailed view of ramp geometry of a curvilinear ramp of the inner camming surface;

FIG. 8 is a schematic illustrating angle of movement of the cam between open and closed positions;

FIG. 9 is an illustrative graph of user force output compared to angle of the handles of a prior art crimp tool;

FIG. 10 is an illustrative graph of a radius of ramp geometry of a prior art crimp tool;

FIG. 11 is an illustrative graph of a rate of change of the radius of the ramp geometry of a prior art crimp tool;

FIG. 12 is an illustrative graph of user force output compared to angle of the handles of a crimp tool of FIG. 1;

FIG. 13 is an illustrative graph of a radius of ramp geometry of the crimp tool of FIG. 1;

FIG. 14 is an illustrative graph of a rate of change of the radius of the ramp geometry of the crimp tool of FIG. 1; and

FIG. 15 is an illustrative graph comparing differences of a force produced on handles of a crimp tool in response to the various ramp profile geometries of the inner camming surface.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. For example, the invention may be powered manually, electrically, pneumatically, or hydraulically. Rather, these embodiments are provided so that this disclosure will be thorough and complete, and will fully convey the scope of the invention to those skilled in the art. Like numbers refer to like elements throughout.

Referring now to FIG. 1, a crimp tool in accordance with the invention is generally designated 100. The crimp tool 100 includes a cam handle 102 pivotally connected to a lower handle 104. The crimp tool 100 is operated by compressing the cam handle 102 and the lower handle 104 together. This action results in a crimping action as described in detail below.

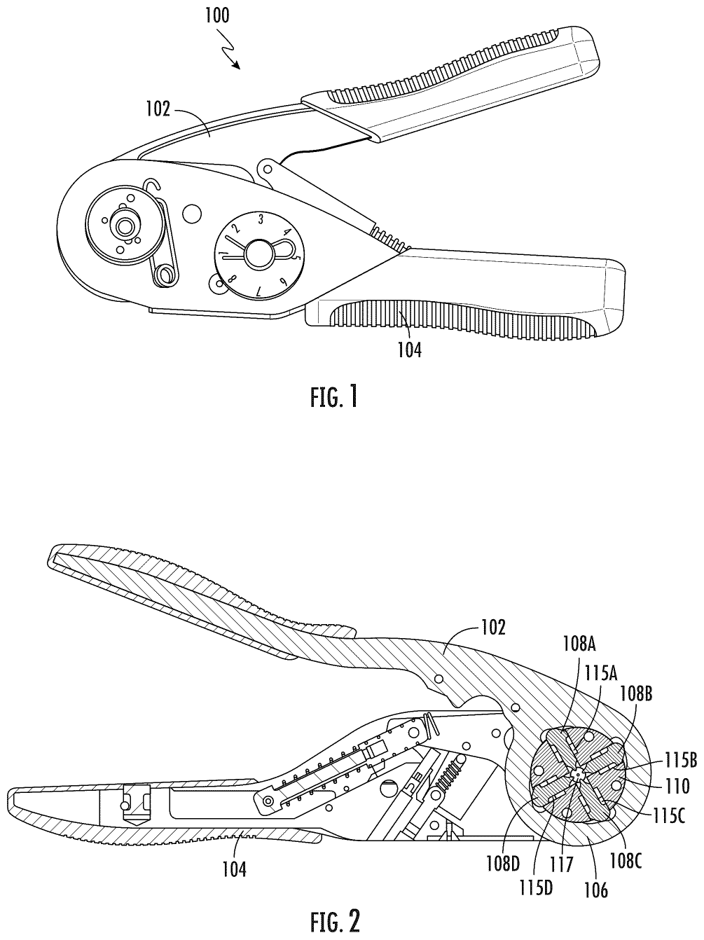

A cross-sectional view is shown in FIG. 2 that illustrates that the cam handle 102 extends from a circular cam 106. The lower handle 104 is coupled to an indentor holder 110 so that the circular cam 106 can rotate about the indentor holder 110. The indentor holder 110 includes a plurality of radially extending channels (or holes) 115A, 115B, 115C, 115D, and a plurality of indentor elements 108A, 108B, 108C, 108D are slidingly engaged with the plurality of radially extending channels 115A-D. The crimp tool 100 is in an open position in FIG. 2, where the indentor elements 108A-D are retracted from a central opening 117. The central opening 117 is where the contact wire barrel is placed to crimp it to the wire.

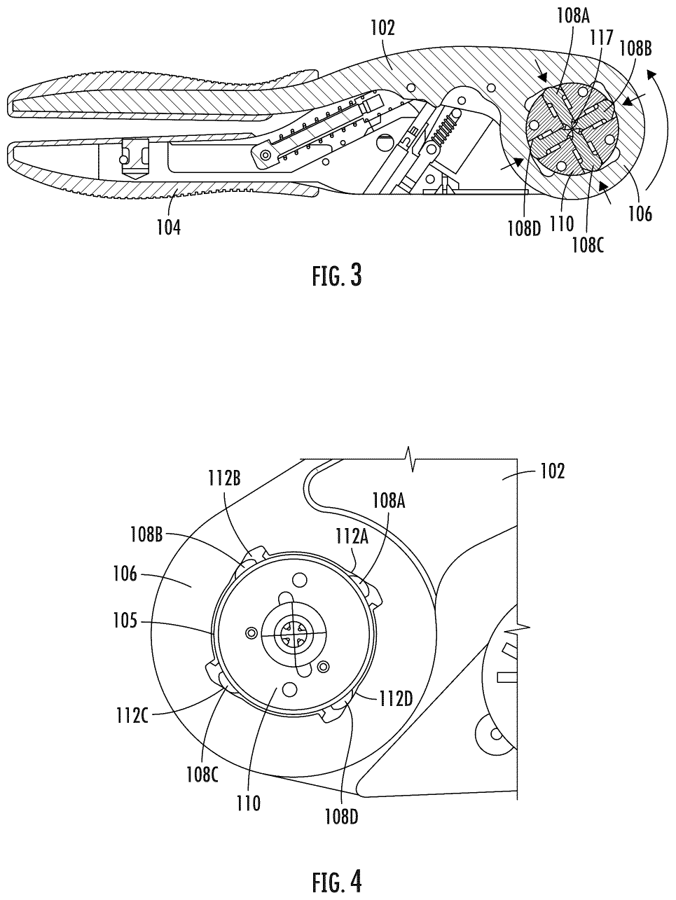

Referring now to FIG. 3, the cam handle 102 is shown compressed and in a closed position. The circular cam 106 is shown having rotated counter-clockwise with the indentor holder 106 remaining relatively stationary to the circular cam 106. The plurality of indenter elements 108A-D have been driven axially inward towards the central opening 117.

A detail view of the distal ends of the plurality indentors 108A-D are illustrated in FIG. 4. An inner camming surface 105 of the circular cam 106 includes a plurality of curvilinear ramps 112A, 112B, 112C, 112D for the plurality of indenter elements 108A-D to slide along as the circular cam 106 rotates from the open position to the closed position. The geometry of the curvilinear ramps 112A-D generates an advantageous non-linear force on the indentor elements 108A-D as the cam handle 102 is compressed. Thus, more force is exerted for larger diameter contact wire barrels and less force for smaller diameter contact wire barrels.

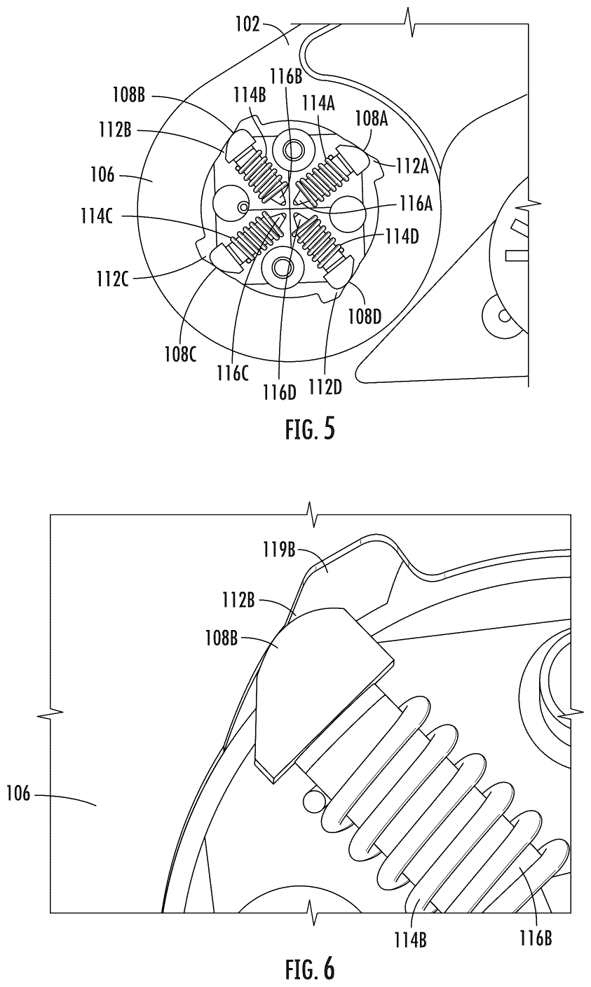

Referring now to FIGS. 5 and 6, the indentor holder 110 has been removed for clarity. Spring elements 114A, 114B, 114C, 114D are positioned to force distal ends of the plurality of the indentor elements to maintain continuous contact with the inner camming surface 105. The distal end of the indentor elements 108A-D may include a rounded head to ensure continuous contact as they ride along the respective ramps 112A-D. In addition, the spring elements 114A-D are biased so that the proximal ends 116A, 116B, 116C, 116D of the plurality of indentor elements 108-D are clear of the central opening 117 when the circular cam 106 is in the open position.

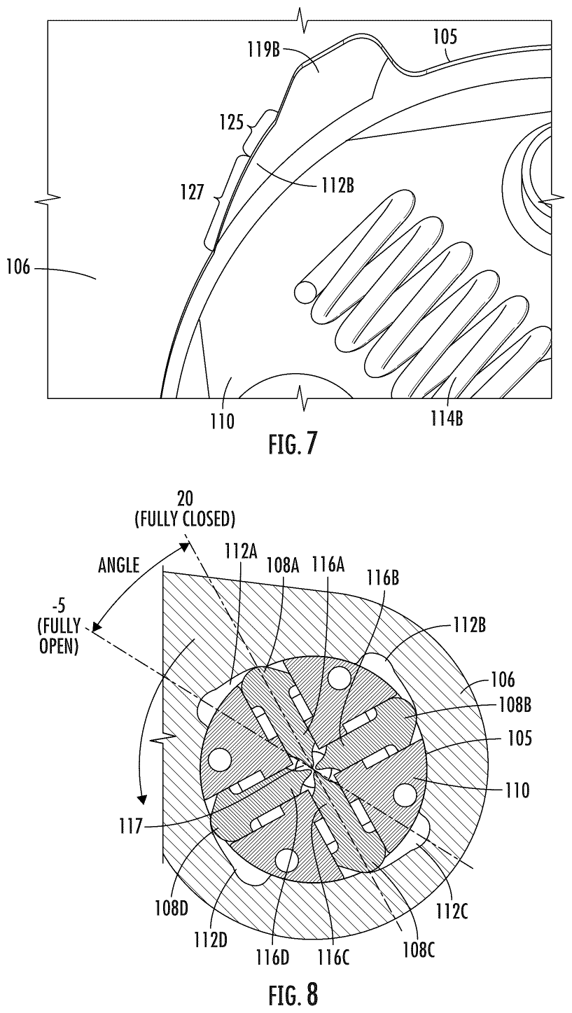

The ramp geometry of the curvilinear ramps 112A-D is illustrated in a detailed view of FIG. 7. The curvilinear ramps 108A-D each have a first portion 125 having a first rate of change in radius, and a second portion 127 having a second rate of change in radius less than the first change in radius. The change in ramp geometry results in change of force exerted as the circular cam 106 rotates from the first portion 125 to the second portion 127 of the inner camming surface 105.

The inner camming surface 105 includes a plurality of recesses 119A-D associated with each curvilinear ramp of the plurality of curvilinear ramps 112A-D and configured to receive a respective rounded head of the plurality of indentor elements 108A-D therein when the circular cam 106 is in the open position.

Referring now to FIG. 8, an exemplary schematic of an angle between the open and closed position is illustrated. The circular cam 106 is shown in the closed position and the indentor elements 108A-D driven inward towards the central opening 117 by the curvilinear ramps 108A-D. In a particular aspect, the angle between open and closed is twenty-five (25) degrees. It will be appreciated that the indentor elements 108A-D do not rotate about central opening 117 but are held fixed in orientation relative to the inner camming surface 105.

The crimping tool 100 is designed with a crimping function such that as the handles 102, 104 of the tool 100 are compressed towards each other, the crimping action completes the crimping of the contact wire barrel onto the wire. In this manner, the pressure on the indenter elements 108A-D against the contact wire barrel stays until the handles 102, 104 are opened thus allowing the crimped wire and contact wire barrel to be released from the crimping tool 100.

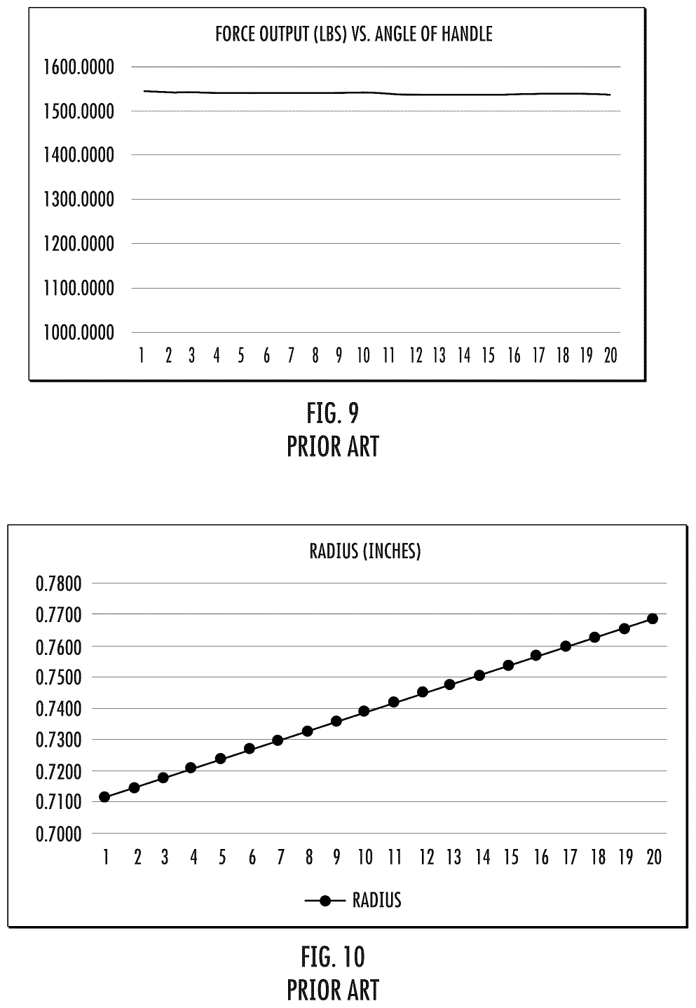

FIG. 9 shows an illustrative graph of user force output as the handles of a prior art crimp tool are compressed. The graph represents the handles being compressed and an actuator rotating from zero (0) degrees of an open position to twenty (20) degrees of a closed position. The user force output is linear based on a constant input force and does not change.

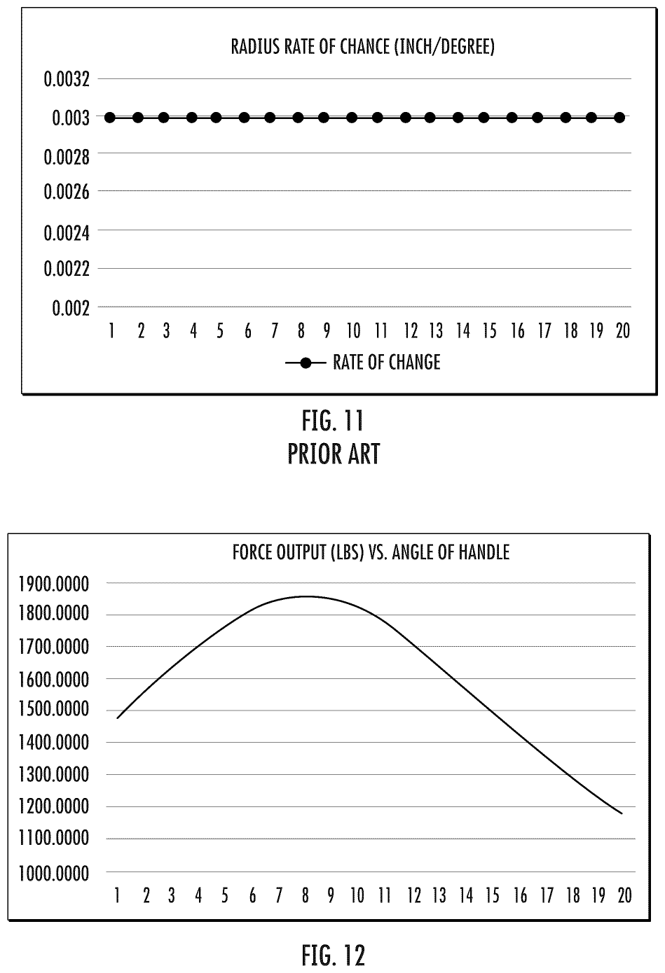

FIG. 10 is an illustrative graph of a measurement of the radius of ramps from a central opening of a prior art crimp tool. The graph represents that a dimension of the ramp relative to the rotation of the actuator is linear. The rate of change in the dimension of the radius relative to rotation of the actuator is constant as illustrated in FIG. 11.

Referring now to FIG. 12, an illustrative graph of user force output as the handles of the crimp tool 100 are compressed. The graph represents the handles being compressed and the circular cam 106 rotating from zero (0) degrees of an open position to twenty (20) degrees of a closed position as shown in FIG. 8. The user force output initially increases as needed for larger contact wire barrels, then the output force decreases for smaller contact wire barrels as less force is needed for the crimping process. Accordingly, ergonomics are improved and a secure connection between the contact wire barrel is achieved with the crimp tool 100 whether the contact wire barrel is large or small as can be appreciated by those of ordinary skill in the art. It should be noted that this graph is merely illustrative of the force for a similar device, and is not meant to indicate that the crimp tool 100 may or must conform to this representation.

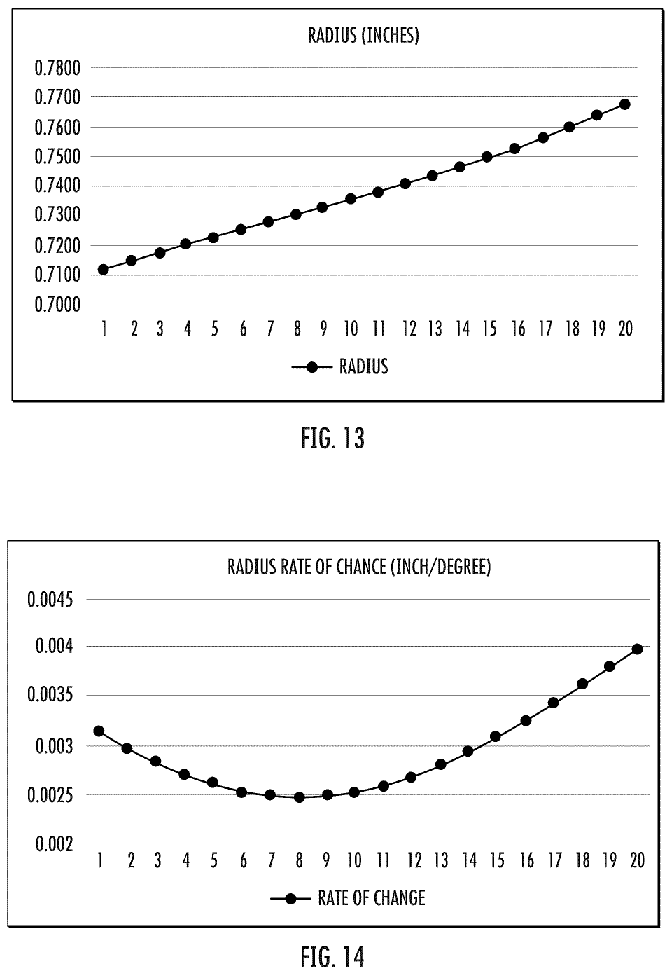

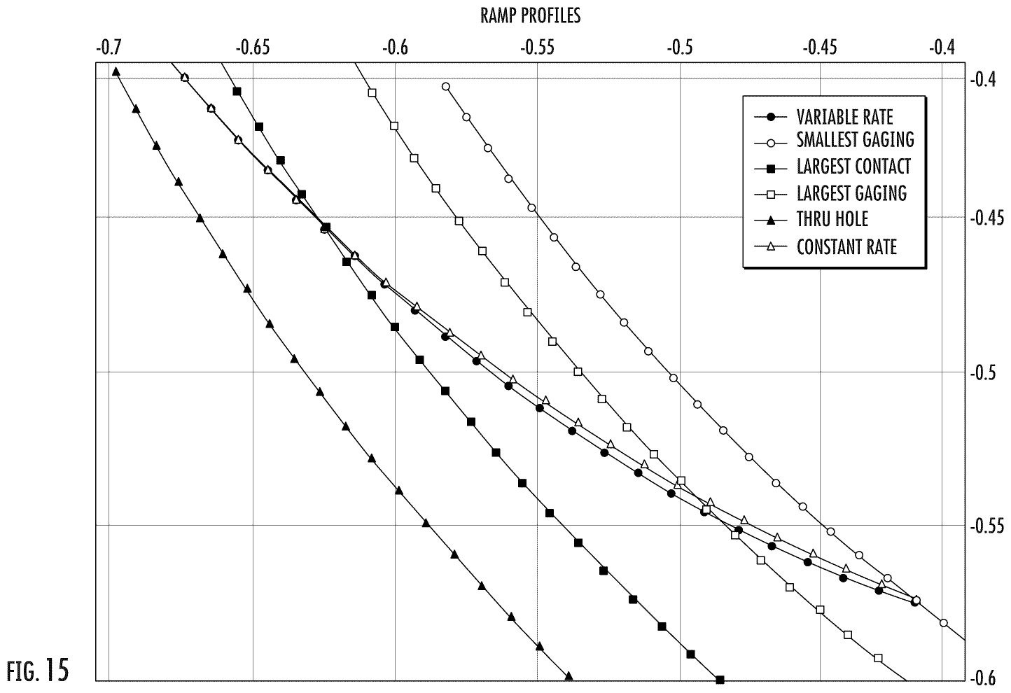

FIG. 13 is an illustrative graph showing how the dimension of the radius of circular ramps 112A-D changes to form the novel and improved ramp geometry. FIG. 14 is an illustrative graph of a rate of change of the radius of the circular ramps 112A-D.

FIG. 15 is an illustrative graph comparing differences of a force produced on handles of a crimp tool in response to the various ramp profile geometries of the inner camming surface 105.

A method of using a crimp tool 100 described above includes compressing a cam handle 102 extending from the circular cam 106 that causes the circular cam 106 to rotate. The method also includes driving the plurality of indentor elements 112A-D radially inward by the plurality of curvilinear ramps 108A-D in response to the rotation of the circular cam 106 to crimp a prepared wire into a corresponding contact wire barrel.

As discussed above, the plurality of curvilinear ramps 112A-D include a first portion 125 having a first rate of change in radius, and a second portion 127 having a second rate of change in radius different than the first change in radius as illustrated in FIG. 14. Thus, a force exerted by proximal ends 116A-D of the plurality of indentor elements 112a-D on the contact wire barrel changes as the circular cam 106 rotates to a closed position.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A crimp tool for crimping a prepared wire into a corresponding contact wire barrel, the crimp tool comprising:
a circular cam having an aperture therein, the aperture forming an inner camming surface;
a cam handle extending from the circular cam;
a lower handle pivotably connected to the cam handle at the circular cam;
an indentor holder mounted within the aperture of the circular cam, the indentor holder having a plurality of radially extending channels; and
a plurality of indentor elements slidingly engaged with the plurality of radially extending channels;
wherein the inner camming surface having a plurality of curvilinear ramps for the plurality of indenter elements to slide along as the circular cam rotates from an open position to a closed position.

2. The crimp tool of claim 1, wherein the plurality of curvilinear ramps having at least one change in ramp geometry.

3. The crimp tool of claim 2, wherein the plurality of curvilinear ramps comprises a first portion having a first rate of change in radius, and a second portion having a second rate of change in radius less than the first change in radius.

4. The crimp tool of claim 1, wherein rotation of the circular cam from an open position to a closed position is configured to drive the indentor elements radially inward.

5. The crimp tool of claim 1, further comprising a plurality of spring elements forcing distal ends of the plurality of the indentor elements to maintain continuous contact with the inner camming surface.

6. The crimp tool of claim 1, wherein the distal ends of the plurality of indentor elements comprise a rounded head to continuously maintain contact with the inner camming surface.

7. The crimp tool of claim 6, wherein the inner camming surface comprises a plurality of recesses associated with each ramp of the plurality of curvilinear ramps and configured to receive a respective rounded head of the plurality of indentor elements therein when the circular cam is in the open position.

8. The crimp tool of claim 1, wherein a force exerted by proximal ends of the plurality of indentor elements on a contact wire barrel changes as the circular cam rotates to the closed position.

9. The crimp tool of claim 8, wherein the indentor holder remains stationary relative to the circular cam that is configured to rotate when the cam handle is compressed towards the lower handle.

10. A crimp tool for crimping a prepared wire into a corresponding contact wire barrel, the crimp tool comprising:
a circular cam having an aperture therein, the aperture forming an inner camming surface;
a cam handle extending from the circular cam; and
a lower handle pivotably connected to the cam handle at the circular cam;
wherein the inner camming surface having a plurality of curvilinear ramps.

11. The crimp tool of claim 10, further comprising an indentor holder mounted within the aperture of the circular cam, the indentor holder having a plurality of radially extending channels or holes.

12. The crimp tool of claim 11, further comprising a plurality of indentor elements slidingly engaged with the plurality of radially extending channels.

13. The crimp tool of claim 12, wherein the inner camming surface configured for the plurality of indenter elements to slide along as the circular cam rotates from an open position to a closed position.

14. The crimp tool of claim 10, wherein the plurality of curvilinear ramps having at least one change in ramp geometry.

15. The crimp tool of claim 10, wherein the plurality of curvilinear ramps comprises a first portion having a first rate of change in radius, and a second portion having a second rate of change in radius different than the first change in radius.

16. The crimp tool of claim 13, wherein rotation of the circular cam from an open position to a closed position is configured to drive the indentor elements radially inward.

17. The crimp tool of claim 16, wherein ramp geometry of the plurality of curvilinear ramps is configured so that a force exerted by proximal ends of the plurality of indentor elements on a contact wire barrel changes as the circular cam rotates to the closed position.

18. A method of using a crimp tool comprising a circular cam having an inner camming surface and the inner camming surface having a plurality of curvilinear ramps, the method comprising:
compressing a cam handle extending from the circular cam that causes the circular cam to rotate; and
driving a plurality of indentor elements radially inward by the plurality of curvilinear ramps in response to the rotation of the circular cam to crimp a prepared wire into a corresponding contact wire barrel.

19. The method of claim 18, wherein the plurality of curvilinear ramps comprises a first portion having a first rate of change in radius, and a second portion having a second rate of change in radius different than the first change in radius.

20. The method of claim 19, wherein a force exerted by proximal ends of the plurality of indentor elements on the contact wire barrel changes as the circular cam rotates to a closed position.
